(19) United States
(12) Patent Application Publication
(10) Pub. No.: US 2005/0095575 A1
(43) Pub. Date: May 5, 2005

(54) Nail art training and display device

(76) Inventor: Chul H. Choe, Ellicott City, MD (US)

Correspondence Address: CHUL HONG CHOE, 10043 WATERFORD DR., ELLICOTT CITY, MD, 21042, US

(21) Appl. No.: 10/698,419

(22) Filed: Nov. 3, 2003

(51) Int. Cl. G09B 25/00

(52) U.S. Cl. 434/395

(57) ABSTRACT

This invention provides neophyte or experienced nail technicians and nail artists a variety of sizes and shapes simulated fingernails for practice in nail enhancements and hand-painted nail art or airbrushing nail art. The device simulates the human finger in size, shape and weight, and may be reused after the enhancements are removed. In addition, the device will be used to display a variety of nail enhancements, colors of nail polishes, and nail art designs for review by prospective customers of such nail enhancements.

### CROSS-REFERENCE TO RELATED APPLICATIONS.

Not Applicable

### STATEMENT REGARDING FEDERALLY SPONSORED RESEARCH OR DEVELOPMENT.

Not Applicable

Reference to a “Microfiche appendix.”

Not Applicable

### BACKGROUND OF THE INVENTION

1. Field of the Invention

This invention relates to training devices for practicing in hand-painted nail art, nail enhancements and for displaying the appearance of enhanced nail art, nail enhancements and the colors of nail polishes used on the devices.

2. Description of Related Art Including Information Disclosed Under 37 CFR 1.97 and CFR 1.98

This invention is a training device comprised of a holder with attached simulated fingernails for use by persons learning to paint nail art and nail enhancements and decorate human fingernails. The simulated fingernails may be just polished, painted nail art or enhanced for using as a means of displaying such decorations and colors of fingernails for review by prospective customers for such enhancements.

U.S. Pat. No. 5,133,369 discloses a method of applying nail polish in which the polish is floated on the surface of a liquid. The finger is dipped into the liquid and the polish adheres to the finger.

U.S. Pat. No. 5,450,864 discloses artificial nail tips shaped to conform to the user's natural fingernails.

U.S. Pat. No. 5,482,057 discloses a wand attached to a stand to which artificial fingernails are removable and attached by means of sticky tape.

U.S. Pat. No. 5,570,793 discloses a fingernail color display with platforms to which artificial fingernails are attached for commercial display.

U.S. Pat. No. 6,012,461 discloses a sculptured fingernail training system for the creation of artificial fingernails. A cylinder simulating a human finger receives a form which outlines the shape of the artificial fingernail to be formed by the addition of liquid artificial fingernail material.

U.S. Pat. No. 6,354,304 discloses an artificial fingernail having layers of differing color which is attached to a natural fingernail.

U.S. Pat. No. 6,354,447 discloses a fingernail color display device in which artificial fingernails are attached to the ends of cylindrical rods which, in turn, are mounted in a vertical position in a rack.

U.S. Pat. No. 6,488,506 discloses a training aid for application of false nails in the form of an artificial hand with artificial fingers to which false nails are attached.

None of the discovered prior art meets the need met by the present invention, that of providing a training device which substitutes for the use of human models for the training of nail technicians and nail artists. The present invention is a training device with multiple simulated fingernails at either end of a holder for use in practicing the nail art and decoration of fingernails and nails enhancements. The training device also will be used as a display for nail art, nail enhancements, and colors of fingernails for review by prospective customers for such decoration.

### BRIEF SUMMARY OF THE INVENTION.

The training of nail technicians and nail artists is hampered by the lack of human models whose fingernails may be practiced. The use of human models is prohibitively expensive and limited by health problems associated with multiple applications to and removal of fingernail paint and other nail enhancements from human fingers that need to be sanitized and disinfected. This invention simulates a human finger with a multiplicity of nails having a variety of sizes and shapes. The device may be reused after enhancements are removed. In addition, the device, when the nail portions are enhanced, serves as a means for displaying a variety of fingernail enhancements. A kit comprising a device, nail art paints, brushes, training aids, decorating materials and an instruction booklet also is disclosed.

The nail enhancement device of this invention comprises a cylindrical handle having a circumference at least at one end and a multiplicity of nails which simulate human fingernails in size and shape. Each nail has a proximal and a distal end, the nails are attached by the proximal ends to at least one end of the handle, and the nails are arrayed about the circumference of the end of the handle with a gap between adjacent nails.

Also disclosed is a kit for the training of operators in nail enhancement methods comprise a nail enhancement training device, nail enhancement materials, tools for the application of nail enhancement materials, and instructional materials for teaching the methods of nail enhancement.

Also disclosed is a method for training an operator in nail enhancement methods comprising the steps of grasping a nail enhancement training device having at least one end and having at least one nail extending from the end in one hand of the operator with the nail to be treated extending from the little finger side of the grasping hand, and applying nail enhancement materials to the nail to be treated using the operator's other hand.

Also disclosed is a method of displaying nails which simulate human nails having nail enhancements to prospective customers for nail enhancement services. The method comprises the steps of applying nail enhancements to two or more nails on a nail enhancement training device having a multiplicity of nails extending from at least one end of the device, and allowing a prospective customer for nail enhancement services to examine the nails having nail enhancements.

An objective of one embodiment of the invention is to provide a multiplicity of simulated fingernails for the practice of painting nail art and nail enhancements.

Another objective of one embodiment of the invention is to provide a training device of size and weight simulating a human finger having a multiplicity of simulated fingernails for the practice of painting nail art and nail enhancements.

Another objective of one embodiment of the invention is to provide a multiplicity of simulated fingernails for the display of nail art, nail enhancements and colors of nail polishes.

Another objective of one embodiment of the invention is to provide a kit with components required for the practice of painting nail art and nail enhancements.

A final objective of one embodiment of the invention is to provide a device for the practice of painting nail art and nail enhancements which is inexpensive and easy to manufacture without adverse effects on the human models and environment.

### BRIEF DESCRIPTION OF THE SEVERAL VIEWS OF THE DRAWING

FIG. 1 is a perspective view of the first embodiment of the nail enhancement training device.

FIG. 2 is a side view of the first embodiment of the nail enhancement training device.

FIG. 3 is a cross section view of the first embodiment of the nail enhancement training device.

FIG. 4 is the first embodiment of the nail enhancement training device of FIG. 1 with a longitudinal cut between fingers 15 and 30 to between fingers 35 and 55 and flattened.

FIG. 5 is a bottom plan view of the first embodiment of the nail enhancement training device.

FIG. 6 is a top plan view of the first embodiment of the nail enhancement training device.

### DETAILED DESCRIPTION OF THE INVENTION.

In this patent application of the term “nail enhancements” mean the enhancements of human fingernails by any method such as shaping, polishing, painting nail art, drilling, sculpturing, gelling, overlaying, airbrushing, wrapping, application of decals or inserts, use of stencils, or application of additives giving a stained glass effect. The term “human fingernail” means a natural human fingernail. The term “nail enhancement materials” means materials consumed in the process of nail enhancement such as nail tips, acrylic powder, liquid, gel fabrics, nail polish, nail art paint, airbrush effects, pre-designed or airbrushed nail tips, decals and additives.

FIG. 1 is a perspective view of the first embodiment 10 of the nail enhancement training device. This embodiment is comprised of a body 12 and nails 15, 20, 25, and 30 arrayed about the circumference of one end of the body, and nails 35, 40, 45 and, not visible in FIG. 1, 50 and 55 arrayed about the circumference of the other end. A decorative nail enhancement 19 is shown on finger 19 of FIG. 7. This embodiment has a total length of approximately 115 cm and a diameter of approximately 20 cm. Gaps are made between all the nails, for example, in FIG. 1, gap 18 is between nails 15 and 20, and gap 38 is between nails 35 and 40. The gaps are from 1 to 3 mm in width, with a preferred gap of approximately 2 mm in width. The lengths of all the nails at one end of the handle are approximately the same, although the length of the nails may differ between the ends of the handle. The lengths of the nails vary from 15 mm to 25 mm (regular nails) to 25 mm to 35 mm (long nails). The curvature of the outer surface of the nails approximates the curvature of a human fingernail. The texture of the outer surface of the nails approximates the texture of the human fingernail. The weight of the nail enhancement training device approximates that of a human finger.

FIG. 2 is a side view of the first embodiment 10 of the nail enhancement training device. Visible in FIG. 2 are the body 12, and nails 15, 20, 35 and 40.

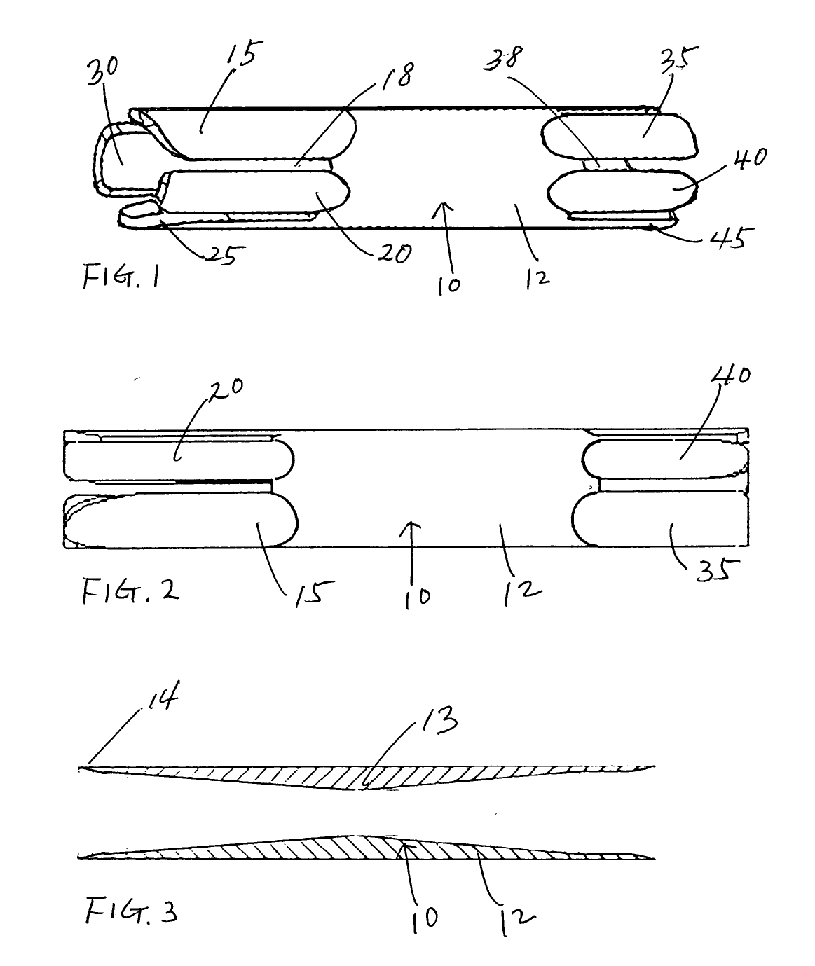

FIG. 3 is a cross section view of the first embodiment of the nail enhancement training device. The wall thickness is not uniform in this embodiment, with a maximum thickness at about the center of the length of the wall, 13, and minimum thickness 14 at the distal ends of the nails. The thickness of the distal ends of the nails is from approximately 0.5 mm to approximately 0.75 mm; the center of the embodiment is approximately 5 mm to 8 mm.

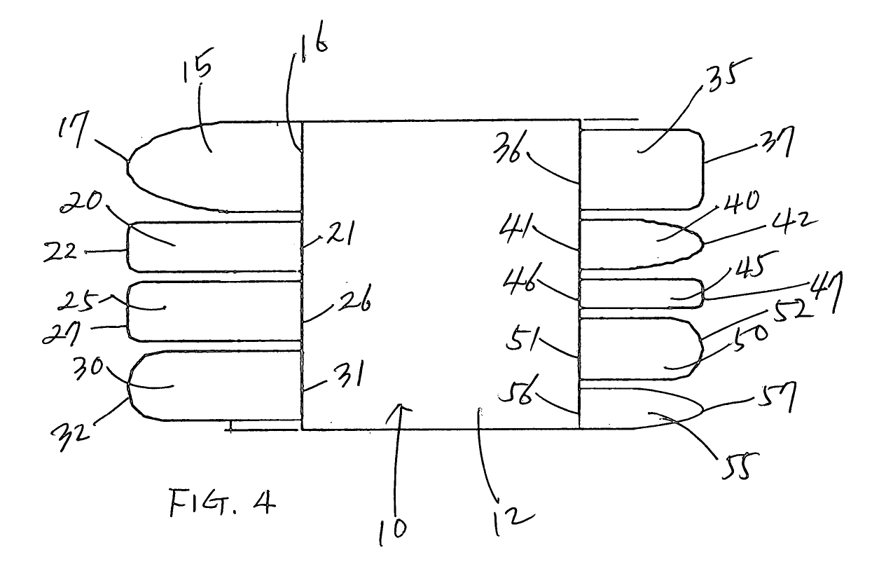

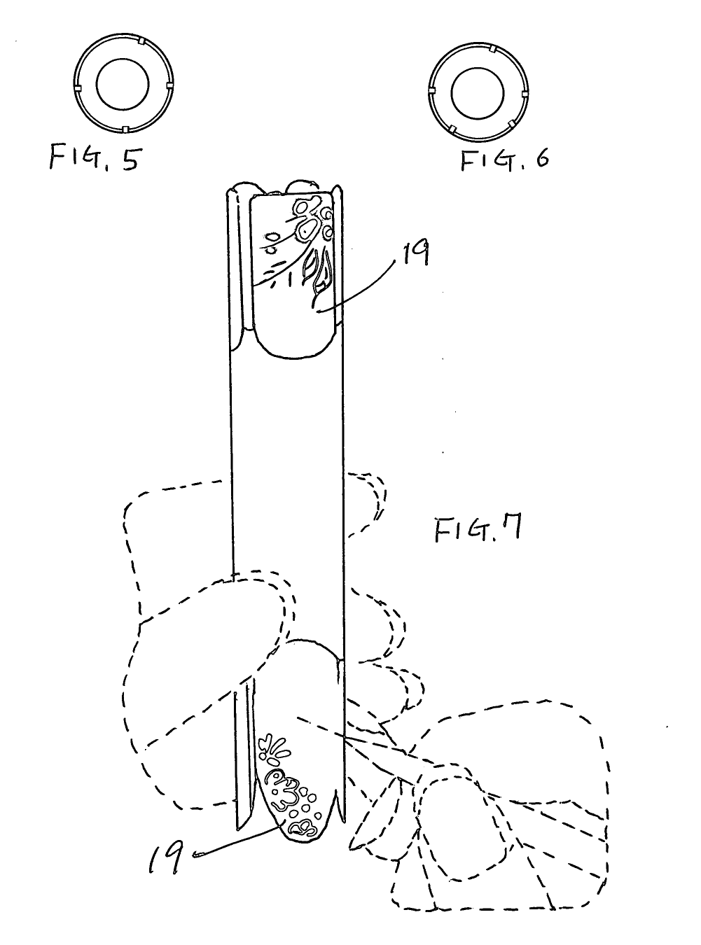

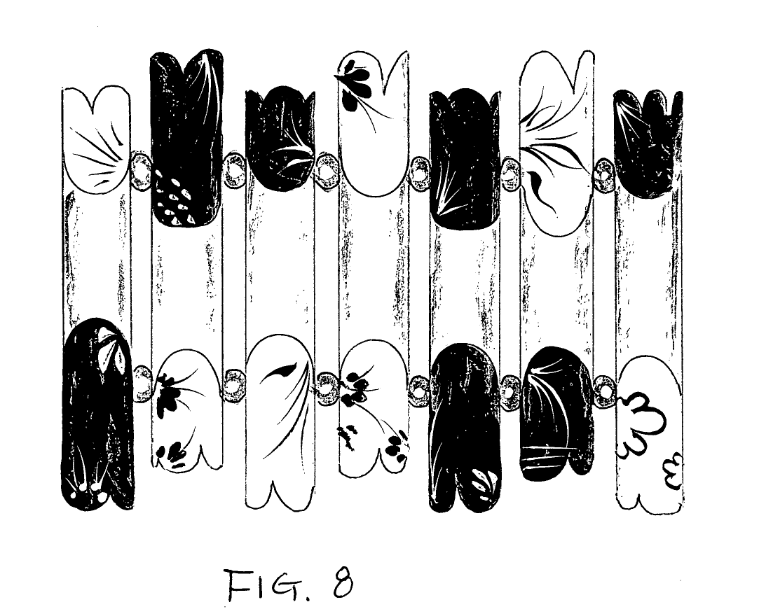

FIG. 4 is the embodiment of the nail enhancement training device of FIG. 1 with a longitudinal cut between nails 15 and 30 to between nails 35 and 55 and flattened. FIG. 4 shows the body 10 with attached nails 15, 20, 25, 30 attached to the circumference at one end of the body and nails 35, 40, 45, 50, and 55 attached to the circumference at the other end of the body.

Nail 15 is attached to the body at the proximal 16 end. The distal end 17 of nail 15 is oval shape nail. Nail 15 is 18 mm wide. Nail 20 is attached to the body at the proximal 21 end. The distal end 22 of nail 20 is square shape with rounded each corner. Nail 20 is 10 mm wide. Nail 25 is attached to the body at the proximal 26 end. The distal end 27 of nail 25 is square shape with rounded each corner. Nail 25 is 12 mm wide. Nail 30 is attached to the body at the proximal 31 end. The distal end 32 of nail 30 is rounded in shape. Nail 30 is 14 mm wide. Nails 15, 20, 25, and 30 are long nails.

Nail 35 is attached to the body at the proximal 36 end. The distal end 37 of nail 35 is square shape with rounded each corner. Nail 35 is 16 mm wide. Nail 40 is attached to the body at the proximal 41 end. The distal end 42 of nail 40 is pointed in shape. Nail 40 is 10 mm wide. Nail 45 is attached to the body at the proximal 46 end. The distal end 47 of nail 45 is square shape with rounded each corner. Nail 45 is 6 mm wide. Nail 50 is attached to the body at the proximal 51 end. The distal end 52 of nail 50 is rounded in shape. Nail 50 is 12 mm wide. Nail 55 is attached to the body at the proximal 56 end. The distal end 57 of nail 55 is pointed in shape. Nail 55 is 8 mm wide. Nails 35, 40, 45, 50, and 55 are regular nails.

The nail enhancement training device may be manufactured of any suitable hard, rigid material which is resistant to the effects of nail enhancements such as fingernail polish and decorations, and acetone based chemicals to remove such nail enhancements. The device surface also must be resistant to abrasion. Suitable materials include plastic and wood. A preferred material is plastic having a color which simulates the color of a human fingernail or any colors of artificial nail tips.

The embodiments of nail enhancement training devices of this patent application may be incorporated into kits for the instruction of nail enhancement operators. A representative kit comprises a nail enhancement training device, tools for the application of nail enhancement materials, and an instruction booklet which provides instruction in the application of nail enhancement materials.

The method of training an operator and applying any nail enhancements by experienced operator as seen in FIG. 7, using the nail enhancement training device, includes the following steps: grasping a nail enhancement training device by the operator with the operator's fingers and thumb engulfing the device and the nail to be treated extending from the little finger side of the operator's hand, and applying nail enhancement materials to the nail to be treated using the operator's other hand. The enhanced, hand-painted nail art designs on the nails, 19 are shown on FIG. 7. The nail enhancement materials may be removed from the treated nail using polish remover, alcohol, filing board, drill and conventional methods of cleaning nails. The operator then may reuse the device and reapply nail enhancement materials to the nail.

The nail enhancement training device may also be used to display various nail enhancements to be offered to prospective customers. One or more, preferably all, of the nails on a nail enhancement training device are treated with the

1. A nail enhancement training device comprising:
a cylindrical handle having a circumference at least at one end,
a multiplicity of nails which simulate human fingernails in size and shape
each nail having a proximal and a distal end,
the nails attached by the proximal ends to at least one end of the handle,
the nails arrayed about the circumference of the end of the handle with a gap between adjacent nails.

2. The nail enhancement training device of claim 1 wherein the distal ends of the nails have a thickness of from approximately 0.5 mm to approximately 1.25 mm.

3. The nail enhancement training device of claim 1 wherein the distal ends of the nails are pointed, square shape with rounded each corner, round, or oval-shaped.

4. The nail enhancement training device of claim 1 wherein the weight of the device approximates that of a human finger.

5. The nail enhancement training device of claim 1 wherein the gap between the nails is approximately 2 mm.

6. The nail enhancement training device of claim 1 wherein the width of the nails is from 4 mm to 25 mm.

7. The nail enhancement training device of claim 1 wherein the length of the device is approximately 115 cm and the diameter of the device is approximately 20 cm.

8. The nail enhancement training device of claim 1 wherein the material of construction is plastic.

9. The nail enhancement training device of claim 1 wherein curvature of the nails approximates the curvature of a human fingernail.

10. The nail enhancement training device of claim 1 wherein the nails have a surface which feels like the surface of a human fingernail.

11. A kit for displaying the nail art and the colors of nail polishes in nail enhancement methods comprising:
a nail enhancement training device,
nail enhancement materials,
tools for the application of nail enhancement materials, and
instructional materials for teaching the methods of nail enhancement.

12. The method of training an operator in nail enhancement comprising the steps:
a. grasping a nail enhancement training device by the operator with the operator's fingers and thumb engulfing the device and the nail to be treated and
b. applying nail enhancement materials to the nail to be treated using the operator's other hand.

13. The method of training an operator in nail enhancement of claim 12 further comprising the step following step b.:
c. removing the nail enhancement materials from the nail.

14. The method of training an operator in nail enhancement of claim 13 further comprising the step following step c.:
d. applying nail enhancement materials to the nail from which nail enhancement materials have been removed.

15. The method of displaying nails which simulates human nails having nail enhancements to prospective customers for nail enhancement services comprising the steps:
a. applying nail enhancements to two or more nails on a nail enhancement training device, and
b. allowing a prospective customer for nail enhancement services to examine the nails having nail enhancements.

16. The method of displaying nails which simulates human nails having nail enhancements to prospective customers for nail enhancement services of claim 15 further comprising the step after step b.:
c. selecting a nail enhancement by the prospective customer for nail enhancements.

17. The method of displaying nail art and nail enhancements which simulate humans nails show the nail enhancements to prospective customers for nail enhancement services wherein the devices are arranged and displayed in a row that stringed together by connecting materials as shown on FIG. 8.
